(19) United States
(12) Patent Application Publication
(10) Pub. No.: US 2026/0194957 A1
(43) Pub. Date: Jul. 9, 2026

(54) POWER STATE SEQUENCING FOR MULTI-CLUSTER CENTRAL PROCESSING UNIT (CPU) ARCHITECTURE

(71) Applicant: QUALCOMM Incorporated, San Diego, CA (US)

(72) Inventors: Dinesh Kumar CHOUDHARY, Tonk (IN); Raja Simha REVANURU, Hyderabad (IN); Maulik SHAH, Hyderabad (IN); Srinivas Rao LENGAMANENI, Hyderabad (IN); Rupendra KARRI, Peddapuram (IN)

(21) Appl. No.: 19/012,459

(22) Filed: Jan. 7, 2025

(51) Int. Cl. G06F 1/324

(52) U.S. Cl. CPC G06F 1/324

(57) ABSTRACT

A method of low power mode sequencing includes running a central processing unit (CPU) at a first clock speed. The method also includes determining whether a low power mode is selected in response to cluster mode triggering. The method further includes entering the low power mode in response to the low power mode being selected. The method also includes waiting for an interrupt that will trigger exit of the low power mode, while in the low power mode. The method further includes determining whether a lower clock speed is selected while waiting for the interrupt. The method also includes reducing a clock speed of the CPU in response to the lower clock speed being selected. The method further includes restoring the clock speed to the first clock speed in response to receiving the interrupt. The method also includes exiting the low power mode in parallel with restoring the clock speed.

### BACKGROUND

### Field

Aspects of the present disclosure relate to computing devices, and more specifically to power state sequencing for a multi-cluster central processing unit (CPU) architecture.

### Background

Mobile or portable computing devices include mobile phones, laptop, palmtop and tablet computers, portable digital assistants (PDAs), portable game consoles, and other portable electronic devices. Mobile computing devices are comprised of many electrical components that consume power and generate heat. The components (or compute devices) may include system-on-a-chip (SoC) devices, central processing unit (CPU) devices, graphics processing unit (GPU) devices, neural processing unit (NPU) devices, digital signal processors (DSPs), and modems, among others.

The compute devices, such as CPU devices, may enter low power modes to save power. Various types of low power modes may be available for each compute device. It would be desirable to coordinate entry and exit from the various types of low power modes to improve power savings.

### SUMMARY

In aspects of the present disclosure, a method of low power mode sequencing includes running a central processing unit (CPU) at a first clock speed. The method also includes determining whether a low power mode is selected in response to cluster mode triggering. The method further includes entering the low power mode in response to the low power mode being selected. The method still further includes waiting for an interrupt that will trigger exit of the low power mode, while in the low power mode. The method also includes determining whether a lower clock speed is selected while waiting for the interrupt. The method further includes reducing a clock speed of the CPU in response to the lower clock speed being selected. The method still further includes restoring the clock speed to the first clock speed in response to receiving the interrupt. The method also includes exiting the low power mode in parallel with restoring the clock speed.

Other aspects of the present disclosure are directed to an apparatus. The apparatus has one or more memories and one or more processors coupled to the one or more memories. The processor(s) is configured to run a central processing unit (CPU) at a first clock speed. The processor(s) is also configured to determine whether a low power mode is selected in response to cluster mode triggering. The processor(s) is further configured to enter the low power mode in response to the low power mode being selected. The processor(s) is still further configured to wait for an interrupt that will trigger exit of the low power mode, while in the low power mode. The processor(s) is also configured to determine whether a lower clock speed is selected while waiting for the interrupt. The processor(s) is further configured to reduce a clock speed of the CPU in response to the lower clock speed being selected. The processor(s) is still further configured to restore the clock speed to the first clock speed in response to receiving the interrupt. The processor(s) is also configured to exit the low power mode in parallel with restoring the clock speed.

In other aspects of the present disclosure, a non-transitory computer-readable medium with program code recorded thereon is disclosed. The program code is executed by a processor and includes program code to run a central processing unit (CPU) at a first clock speed. The program code also includes program code to determine whether a low power mode is selected in response to cluster mode triggering. The program code further includes program code to enter the low power mode in response to the low power mode being selected. The program code still further includes program code to wait for an interrupt that will trigger exit of the low power mode, while in the low power mode. The program code also includes program code to determine whether a lower clock speed is selected while waiting for the interrupt. The program code further includes program code to reduce a clock speed of the CPU in response to the lower clock speed being selected. The program code still further includes program code to restore the clock speed to the first clock speed in response to receiving the interrupt. The program code also includes program code to exit the low power mode in parallel with restoring the clock speed.

This has outlined, rather broadly, the features and technical advantages of the present disclosure in order that the detailed description that follows may be better understood. Additional features and advantages of the present disclosure will be described below. It should be appreciated by those skilled in the art that this present disclosure may be readily utilized as a basis for modifying or designing other structures for carrying out the same purposes of the present disclosure. It should also be realized by those skilled in the art that such equivalent constructions do not depart from the teachings of the present disclosure as set forth in the appended claims. The novel features, which are believed to be characteristic of the present disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following description taken in conjunction with the accompanying drawings.

FIG. 1 illustrates an example implementation of a host system-on-a-chip (SoC), including low power mode coordination, in accordance with certain aspects of the present disclosure.

FIG. 2 is flow chart illustrating performance state (P-state) reduction and low power mode entry and exit.

FIG. 3 is a flow chart illustrating coordination between low power modes, in accordance with various aspects of the present disclosure.

FIG. 4 is a flow chart illustrating coordination between low power modes based on prediction, in accordance with various aspects of the present disclosure.

FIG. 5 is a flow diagram illustrating an example process performed, for example, by a mobile device, in accordance with various aspects of the present disclosure.

FIG. 6 is a block diagram showing an exemplary wireless communications system in which a configuration of the present disclosure may be advantageously employed.

FIG. 7 is a block diagram illustrating a design workstation used for circuit, layout, and logic design of components, in accordance with various aspects of the present disclosure.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. It will be apparent, however, to those skilled in the art that these concepts may be practiced without these specific details. In some instances, well-known structures and components are shown in block diagram form in order to avoid obscuring such concepts.

As described, the use of the term “and/or” is intended to represent an “inclusive OR,” and the use of the term “or” is intended to represent an “exclusive OR.” As described, the term “exemplary” used throughout this description means “serving as an example, instance, or illustration,” and should not necessarily be construed as preferred or advantageous over other exemplary configurations. As described, the term “coupled” used throughout this description means “connected, whether directly or indirectly through intervening connections (e.g., a switch), electrical, mechanical, or otherwise,” and is not necessarily limited to physical connections. Additionally, the connections can be such that the objects are permanently connected or releasably connected. The connections can be through switches. As described, the term “proximate” used throughout this description means “adjacent, very near, next to, or close to.” As described, the term “on” used throughout this description means “directly on” in some configurations, and “indirectly on” in other configurations.

Different low power modes are defined or exercised at different levels of a system. For example, low power modes may be defined at a core level, cluster level, system level, or overall system-on-a-chip (SoC) level. Different power modes may include clock gating and power gating. Clock gating is a shallow low power mode that quickly returns to normal operating mode when exiting or waking up from the clock gating low power mode. Clock gating, however, may leak power while in the low power mode. Power gating is a deep low power mode that reduces or eliminates power leakage, but specifies longer times (e.g., latency) when cores of a multi-cluster architecture exit the power gating low power modes to become available for scheduling.

Different mechanisms across software, firmware, and/or hardware address coordination between different types of low power modes (e.g., clock gating and power gating). Aggressively reducing the clock speed has a direct penalty on performance, while not reducing the clock speed incurs a penalty on power. This problem is aggravated across high-speed central processing unit (CPU) architectures, such as, for example, multi-cluster CPU architectures.

Aspects of the present disclosure address these challenges, particularly with respect to multi-cluster architecture low power mode designs. Aspects include hardware enhancements for potential power savings across different modes without impacting latencies and performance. Further aspects introduce autonomously triggered sequencing in hardware (e.g., prediction hardening) to increase power savings without impacting performance.

Aspects of the present disclosure introduce a hardware change in the cluster power state machine to consider if further deep power saving states are configured. If so, different states (e.g., clock gating and/or power gating) may be entered. Although clock gating is a shallower low power mode that power gating, power gating does not need to also include clock gating. In some cases, however, both modes may be entered. As the exit timelines of the state machines are higher than performance state (P-state) restoring, core execution is not impacted when the core starts fetching instructions. That is, no performance impact is seen as a restore process is completed before the processor starts software instruction fetching.

Pre-low power mode awareness determines the exact phase recommendation for P-state reduction. That is, where to reduce the P-state is important given that cache flush and other routines are complex and depend on the frequency at which the cluster is running. Aspects also decide at what stage a P-state reduction loop should be invoked when deeper state configurations are scheduled.

Particular aspects of the subject matter described in this disclosure can be implemented to realize one or more of the following potential advantages. In some examples, the described techniques for coordinating low power modes enable additional power savings.

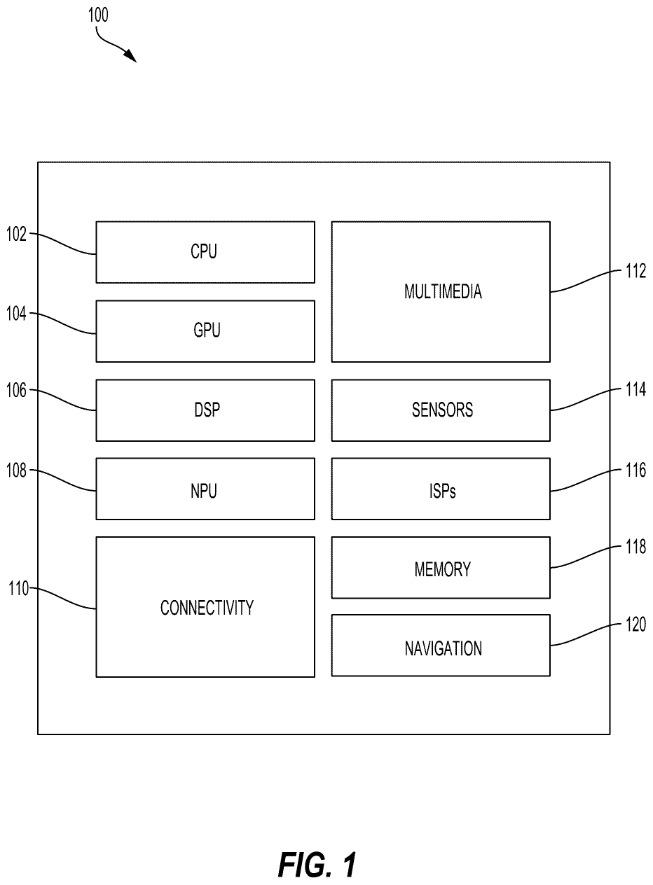

FIG. 1 illustrates an example implementation of a host system-on-a-chip (SoC) 100, which includes low power mode coordination, in accordance with aspects of the present disclosure. The host SoC 100 includes processing blocks tailored to specific functions, such as a connectivity block 110. The connectivity block 110 may include fifth generation (5G) connectivity, fourth generation long term evolution (4G LTE) connectivity, Wi-Fi connectivity, universal serial bus (USB) connectivity, Bluetooth® connectivity, Secure Digital (SD) connectivity, and the like.

In this configuration, the host SoC 100 includes various processing units that support multi-threaded operation. For the configuration shown in FIG. 1, the host SoC 100 includes a multi-core central processing unit (CPU) 102, a graphics processor unit (GPU) 104, a digital signal processor (DSP) 106, and a neural processor unit (NPU) 108. The host SoC 100 may also include a sensor processor 114, image signal processors (ISPs) 116, a navigation module 120, which may include a global positioning system (GPS), and a memory 118. The multi-core CPU 102, the GPU 104, the DSP 106, the NPU 108, and the multimedia engine 112 support various functions such as video, audio, graphics, gaming, artificial networks, and the like. Each processor core of the multi-core CPU 102 may be a reduced instruction set computing (RISC) machine, an advanced RISC machine (ARM), a microprocessor, or some other type of processor. The NPU 108 may be based on an ARM instruction set.

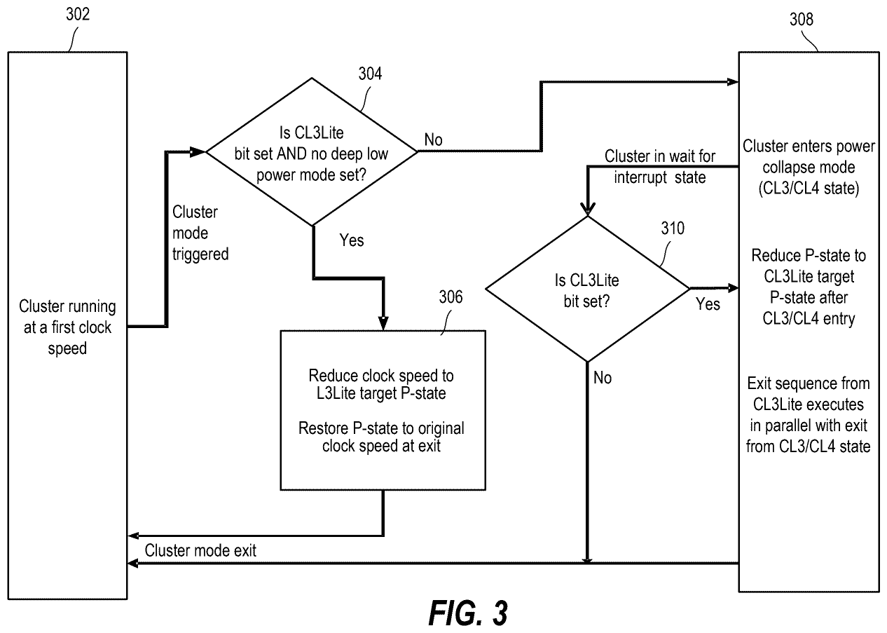

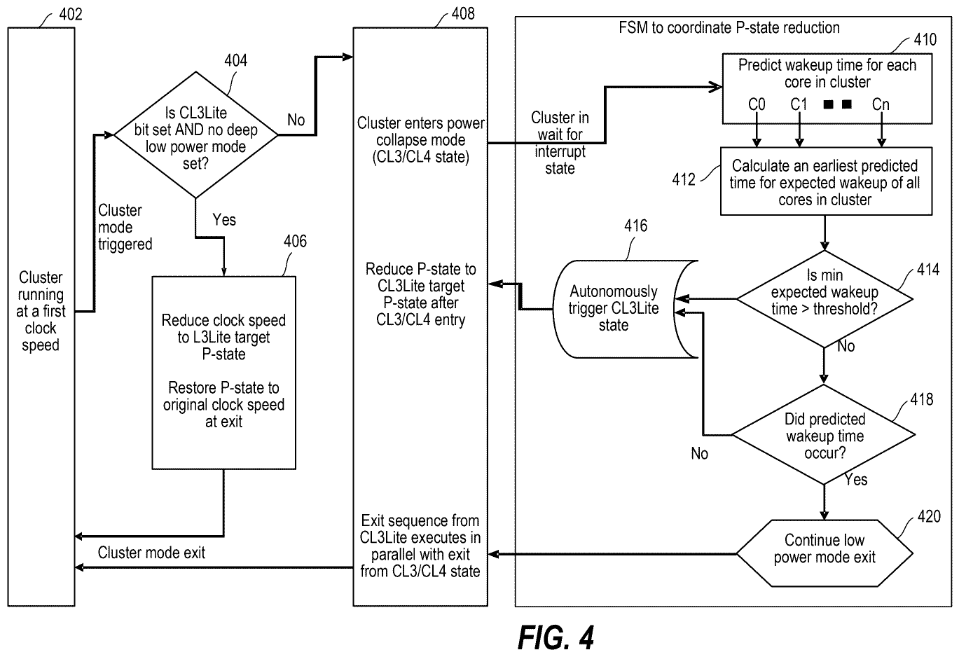

According to aspects of the present disclosure, a mobile device includes a low power mode sequencer or state machines that coordinate hardware executions for low power modes entry, which includes resetting the logic, gating the clocks/power, flushing caches, etc. The low power mode sequencer may include means for running, means for determining, means for entering, means for waiting, means for reducing, means for restoring, means for exiting, means for flushing, and means for predicting. In one configuration, the running means, the determining means, the entering means, the waiting means, the reducing means, the restoring means, the exiting means, the flushing means, and the predicting means may be the state machines, as shown in FIGS. 3 and 4. In other aspects, the aforementioned means may be any structure or any material configured to perform the functions recited by the aforementioned means.

Different low power modes are defined or exercised at different levels of a system. For example, low power modes may be defined at a core level, cluster level, system level, or overall system-on-a-chip (SoC) level. Different power modes may include clock gating and power gating. Clock speed plays a vital role in power consumption, with high-speed central processing units (CPUs) and complex architectures CPUs clocking at 4 gigahertz (GHz) and higher. Higher clock speeds, however, leak more power. Clock gating is a shallow low power mode that quickly returns to normal operating mode when exiting or waking up from the clock gating low power mode. Clock gating, however, may leak power while in the low power mode. Power gating is a deep low power mode that reduces or eliminates power leakage, but specifies longer times (e.g., exit latency) when cores of a multi-cluster architecture exit the power gating low power modes to become available for scheduling. Clock gating stops the clock to some of portions of a core/cluster, depending on the implementation in clock topology as to what level of gating will happen. The actual system clock does not change speed during clock gating. Power gating will be referred to as power collapse, idle mode, CL4, or a deep low power mode.

Different mechanisms across software, firmware, and/or hardware address coordination between different types of low power modes (e.g., clock gating and power gating). Aggressively reducing the clock speed has a direct penalty on performance, while not reducing the clock speed incurs a penalty on power. This problem is aggravated across high-speed CPU architectures, such as, for example, multi-cluster CPU architectures.

Current software-based solutions reduce the P-state in software to slow down the clock speed at which a core or cluster is running. Any software execution after the clock speed reduction adds to performance overhead. A cache flush and context save are executed in hardware when entering a low power mode, resulting in latency and power loss. Restoring context when exiting the low power mode occurs with either hardware or software. When exit timelines increase, performance is impacted. Exit latencies refer to overall overhead of a core before any workload can be scheduled on the core. The latencies encompass all entities involved in the path (e.g., hardware, software, and firmware). If a software controller is employed for save or restore operations, software execution is delayed. Hardware power state machines execute sequences when the core is not executing. Thus, speed reduction for restore operations with hardware has little impact on core execution, which would impact performance.

It is noted that frequency supplies may be per core or per cluster. If the supplies are common to all cores within a cluster, the entire cluster changes P-state. If the supplies are per CPU, then a P-state change may be per core.

For firmware-based solutions, a cluster power state machine coordinates with cluster firmware for reducing the P-state, which is interrupt-based and incurs latencies. The cluster firmware may enter freeze mode to address stability issues. Still, the system should remain capable of waking up or responding to critical events. To enable the system to wake up from the freeze mode, the interrupt should be designated as “wake-capable.” If the cluster firmware is not in a freeze mode, then the cluster firmware may run periodic evaluations, which is a reactive response with a minimum sampling time of 1 millisecond (ms), for example, resulting in additional latency.

For hardware-based solutions, a cluster power state machine executes a P-state reduction first, and if further operations are required in the power state machine, then the P-state is restored. Eventually, additional overhead is incurred for the cache flush or context save timelines, similar to software solutions.

Aspects of the present disclosure address these challenges, particularly with respect to multi-cluster architecture low power mode designs. Aspects include hardware enhancements for potential power savings across different modes without impacting latencies and performance. Further aspects introduce autonomously triggered sequencing in hardware (e.g., prediction hardening) to increase power savings without impacting performance.

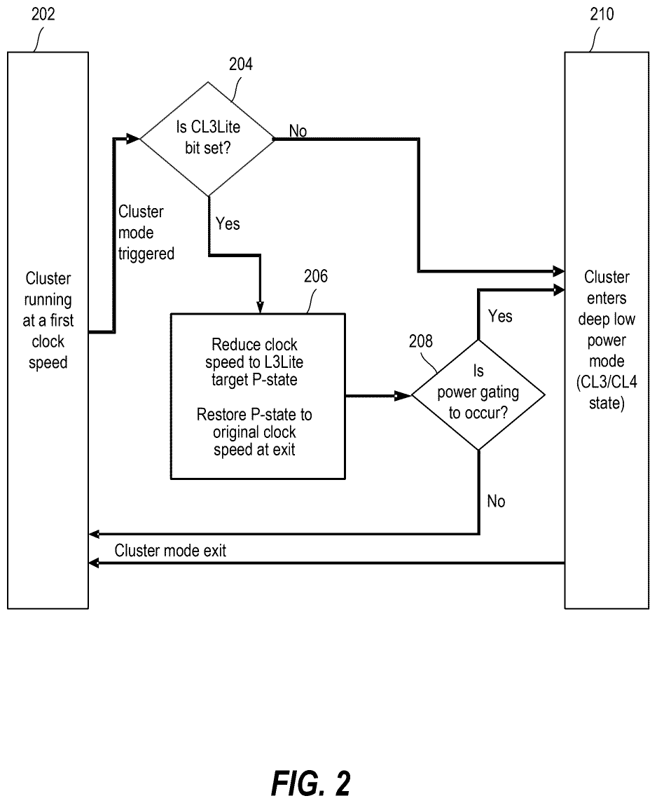

FIG. 2 is a flow chart illustrating performance state (P-state) reduction and low power mode entry and exit. In the example of FIG. 2, at block 202 a CPU cluster is initially running at a first clock speed, for example, 4 GHz. Although the present disclosure is described with respect to CPU clusters, other cluster architectures are also contemplated, such as GPU clusters, NPU clusters, etc. Moreover, although cluster clock speeds are discussed, the individual core clock speed may be adjusted if the frequency sourcing allows such control.

After cluster mode is triggered to enter a low power mode, at block 204, the logic determines whether a CL3Lite bit is set. CL3 Lite is a transient low power mode occurring before cluster power gating (e.g., CL4). Cluster caches are flushed and global context is saved. That is, the logic determines whether clock gating is to occur such that a P-state reduces, for example, to 500 megahertz (MHz). If so, at block 206, the clock speed is reduced to the CL3Lite target P-state. Upon exit of the CL3Lite mode (e.g., clock gating low power mode), the clock speed or P-state restores to the original clock speed, e.g., 4 GHz. If a CL3Lite bit is not set (block 204:No), the cluster enters the deep low power mode (e.g., CL3) at block 210.

Subsequently, at block 208, the logic checks whether power gating (e.g., power gating portions of clusters or a deep state) is to occur. If so, at block 210 the cluster enters the deep low power mode (e.g., CL3/CL4 state). If not (block 208:NO), and also after block 210, the cluster exists the low power mode (e.g., cluster mode). Because the cluster restores the clock speed before entering the deep low power mode, the cluster operates at the higher clock speed (e.g., 4 GHz) when in idle mode (e.g., CL3/CL4 state or the deep low power mode).

FIG. 3 is a flow chart illustrating coordination between low power modes, in accordance with various aspects of the present disclosure. In the example of FIG. 3, at block 302, a CPU cluster is initially running at a first clock speed, for example, 4 GHz. Although the present disclosure is described with respect to CPU clusters, other cluster architectures are also contemplated, such as GPU clusters, NPU clusters, etc. Moreover, although cluster clock speeds are discussed, the individual core clock speed may be adjusted if the frequency sourcing allows such control.

After a cluster mode is triggered to enter a low power mode, at block 304, the logic determines whether a CL3Lite bit is set. That is, the logic determines whether clock gating is to occur, for example, to 500 MHz. At block 304, the logic also checks whether a deep low power mode (LPM) is set. It is noted that low power modes, other than deep low power modes, are also contemplated by the present disclosure. If the CL3Lite bit is set but the deep low power mode is not set (block 304: YES), at block 306, the clock speed is reduced to the CL3Lite target P-state. Upon exit of the CL3Lite mode (e.g., clock gating low power mode), the clock speed or P-state restores to the original clock speed, for example, 4 GHz.

If the CL3Lite bit is set AND the deep low power mode is set (block 304:NO), at block 308, the cluster enters a CL3 or CL4 state. More specifically, the cluster enters a power collapse mode where a level 2(L2 ) cache is flushed to the next level memory (e.g., dynamic random access memory (DRAM) or a system level cache) and the cluster asserts a reset to the cache logic and saves context. If the CL4 state is to be entered, the cluster also opens a globally distributed head switch, preventing power leakage from the L2 cache. The cluster then enters a wait for interrupt (WFI) state. The arrival of an interrupt triggers an exit of the deep low power mode and also an exit of the clock gated low power mode.

While in the WFI state, at block 310, the logic checks whether the CL3Lite bit is set. If the CL3Lite bit is not set, the cluster exits the low power mode in response to receiving an interrupt. If the CL3Lite bit is set, at block 308 the cluster reduces the clock speed to the CL3Lite target P-state (e.g., reducing from 4 GHz to 500 Mhz). The clock speed reduction occurs after the cluster has already entered the idle mode (e.g., CL3/CL4 state).

When exiting the CL3/CL4 state and the CL3Lite state, the cluster in parallel starts the CL3/CL4 exit sequence and the CL3Lite exit sequence. That is, the deep low power mode exits in parallel with restoring the clock speed (e.g., from 500 MHz to 4 GHz). In some aspects, the cluster notifies a dynamic voltage and frequency scaling (DVFS) state machine to restore the clock speed. The CL3 exit sequence may include cache invalidation and other hardware recommended steps, which may take approximately 100 microseconds (μs) in some implementations. The CL4 exit sequence additionally includes closing the globally distributed head switch to restore power to the L2 cache. After the cores exit the low power mode, each core may start executing software.

Aspects of the present disclosure are also related to a finite state machine (FSM) for autonomous triggering of the CL3Lite state. The finite state machine coordinates the P-state based on predictions. With different product segments running with different kernels, prediction accuracy varies and may be worse when supporting multiple ecosystems with the same baseline system. Techniques of the present disclosure mitigate inaccurate predictions by hardening the missed prediction, as explained with respect to FIG. 4.

FIG. 4 is a flow chart illustrating coordination between low power modes based on prediction, in accordance with various aspects of the present disclosure. In the example of FIG. 4, at block 402, a CPU cluster is initially running at a first clock speed, for example, 4 GHz. Although the present disclosure is described with respect to CPU clusters, other cluster architectures are also contemplated, such as GPU clusters, NPU clusters, etc. Moreover, although cluster clock speeds are discussed, the individual core clock speed may be adjusted if the frequency sourcing allows such control.

After a cluster mode is triggered to enter a low power mode, at block 404, the logic determines whether a CL3Lite bit is set. That is, the logic determines whether clock gating is to occur such that a P-state reduces, for example, to 500 MHz. At block 404, the logic also checks whether a deep low power mode (LPM) is set. If the CL3Lite bit is set but the deep low power mode is not set (block 404: YES), at block 406, the clock speed is reduced to the CL3Lite target P-state. Upon exit of the CL3Lite mode (e.g., clock gating low power mode), the clock speed or P-state restores to the original clock speed, e.g., 4 GHz.

If the CL3Lite bit is set AND the deep low power mode is set (block 404:NO), at block 408, the cluster enters the CL3 or CL4 state. More specifically, the cluster enters a power collapse mode where a level 2(L 2 ) cache is flushed to the next level memory (e.g., dynamic random access memory (DRAM)) and the cluster asserts a reset to the cache logic, and saves context. If the CL4 state is to be entered, the cluster also opens a globally distributed head switch, preventing power leakage from the L2 cache. The cluster then enters a wait for interrupt (WFI) state. The arrival of an interrupt triggers an exit of the deep low power mode and also an exit of the clock gated low power mode.

While in the WFI state, the finite state machine starts evaluating whether a P-state switch can be triggered. At block 410, the finite state machine predicts, across all cores of the cluster, an expected wakeup time for each core. For example, core 0 (C0) may be assigned to an SMS app and predicted to wake up in 1 ms, core 1(C1 ) may be predicted to wake up in 10 ms for an expected workload, etc. The predictions may be based upon a recent history, for example, in a predetermined time window. The predictions may be based on how each core is being utilized.

At block 412, the finite state machine calculates an earliest predicted time for the expected wakeup, among all cores in the cluster. At block 414, the finite state machine determines if the minimum value is greater than a threshold time. For example, if the minimum expected wakeup time is 1 ms and the threshold is 0.5 ms, then the minimum exceeds the threshold and the logic proceeds to block 416, where the CL3Lite state is autonomously triggered. The cluster may then reduce the clock speed to the CL3 target P-state (e.g., reducing from 4 GHz to 500 MHz). The clock speed reduction occurs after the cluster has already entered the idle mode (e.g., CL3/CL4 state) and may be performed with the hardware state machine.

If the minimum value is greater than the threshold time, at block 418, it is determined if the prediction is accurate. In other words, it is determined if the predicted wakeup time occurred. If not, the process proceeds to block 416, where the P-state switch occurs. If the predicted wakeup time occurred, at block 420, the cluster exits the low power mode. When exiting the low power mode, the cluster in parallel starts the CL3/CL4 exit sequence and the CL3Lite exit sequence (if the CL3Lite mode was entered).

Further aspects of the present disclosure relate to improvements when exiting the low power modes. For example, the P-state restore can selectively be triggered even before an actual interrupt occurs. In one example, core 0 has a prediction of 1 ms, core 1: 2 ms, core 2: 3 ms, and core 3: 4 ms. In this example, the earliest prediction is 1 ms. Assume the threshold time is 800 μs in this example. Because 1 ms>800 μs, P-state reduction is triggered.

Assume that the P-state restore worst-case timeline is 50 μs. Because the actual predicted wakeup is at 1 ms for core 0, the finite state machine starts P-state restoring at 950 μs to ensure when core 0 wakes up the P-state is fully restored.

Aspects of the present disclosure, introduce a hardware change in the cluster power state machine to consider if further deep power saving states are configured. If so, different states (e.g., CL3Lite) are entered after entry into a low power mode (e.g., the CL3 or CL4 state). As the exit timelines of the state machines are higher than P-state restoring, core execution is not impacted when the core starts fetching instructions. That is, no performance impact is seen as a restore process is completed before the processor starts software instruction fetching. Moreover, no additional overhead is seen in the low power mode path as deeper idle states are attempted with this transition enabled. For example, regular low power modes are not impacted as this transition (both reduction and restore) is based on hardware processing of prediction timelines, preventing overhead to low power modes. As the P-state reduction loop happens after the cache flush or hardware context save and the clock speed is restored before any complex routines are executed, core software fetches are not impacted. Moreover, pre-low power mode awareness determines the exact phase recommendation for P-state reduction, in contrast to prior sequences that involves multiple reduction/restore operations in different phases.

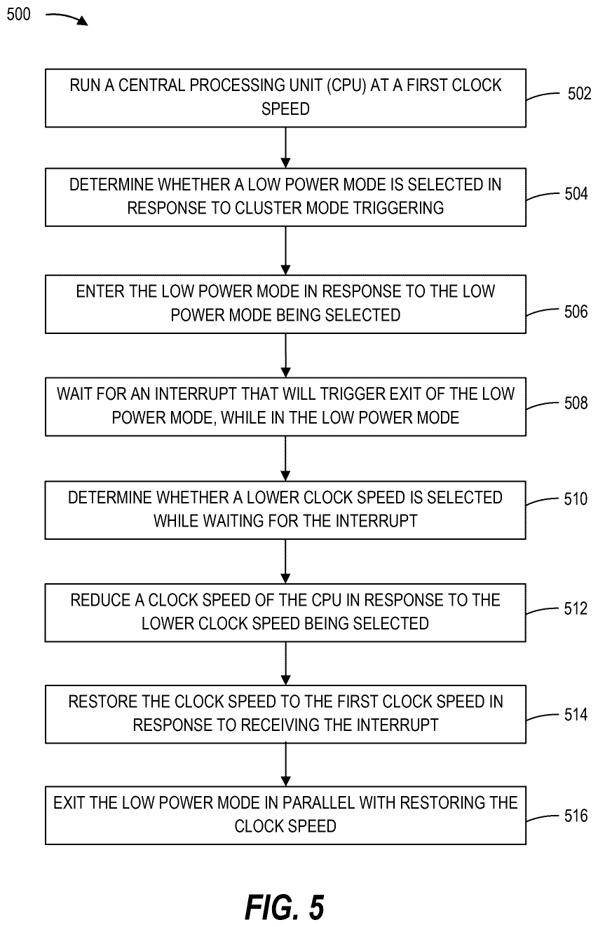

FIG. 5 is a flow diagram illustrating an example process 500 performed, for example, by a mobile device, in accordance with various aspects of the present disclosure. The example process 500 is an example of coordination of low power modes in a multi-cluster architecture. As shown in FIG. 5, in some aspects, the process 500 may include running a central processing unit (CPU) at a first clock speed (block 502). In some aspects, the process 500 may include determining whether a low power mode is selected in response to cluster mode triggering (block 504).

In some aspects, the process 500 may include entering the low power mode in response to the low power mode being selected (block 506). For example, the process may enter the low power mode by flushing a level two cache and resetting cache logic and/or entering a power collapse state. A processor or hardware state machine may perform these functions. In some aspects, the process 500 may include waiting for an interrupt that will trigger exit of the low power mode, while in the low power mode (block 508). In some aspects, the process 500 may include determining whether a lower clock speed is selected while waiting for the interrupt (block 510). In some aspects, the process 500 may include reducing a clock speed of the CPU in response to the lower clock speed being selected (block 512).

In some aspects, the process 500 may include restoring the clock speed to the first clock speed in response to receiving the interrupt (block 514). In some aspects, the process 500 may include exiting the low power mode in parallel with restoring the clock speed (block 516). In some aspects, exiting the low power mode may be in response to an earliest predicted time being accurate when the earliest predicted time is not greater than the threshold time. In some aspects, exiting the low power mode occurs before receiving the interrupt, in accordance with the earliest predicted time. In still other aspects, exiting the low power mode occurs a predetermined time before an earliest predicted time, the predetermined time corresponding to a worst case timeline for restoring the clock speed.

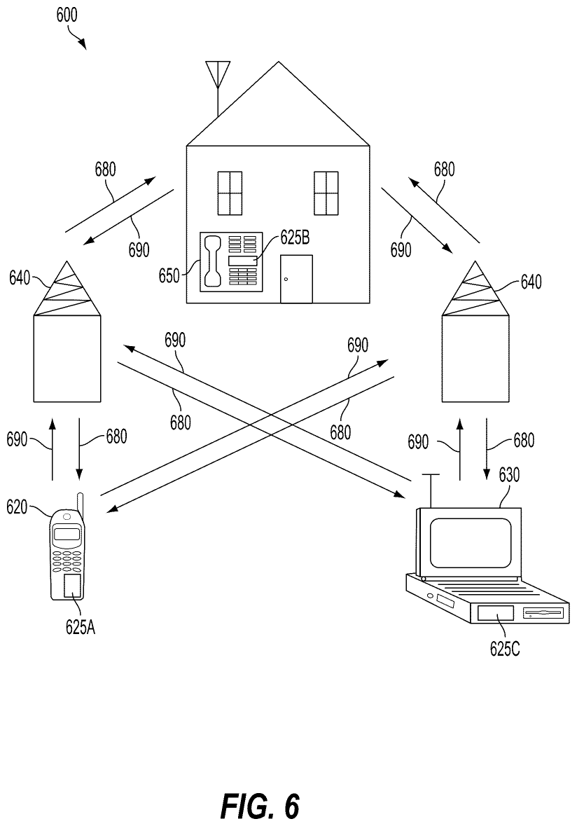

FIG. 6 is a block diagram showing an exemplary wireless communications system 600, in which an aspect of the present disclosure may be advantageously employed. For purposes of illustration, FIG. 6 shows three remote units 620, 630, and 650, and two base stations 640. It will be recognized that wireless communications systems may have many more remote units and base stations. Remote units 620, 630, and 650 include integrated circuit (IC) devices 625A, 625B, and 625C that include the disclosed coordination of low power modes in a multi-cluster architecture. It will be recognized that other devices may also include the disclosed coordination of low power modes in a multi-cluster architecture, such as the base stations, switching devices, and network equipment. FIG. 6 shows forward link signals 680 from the base stations 640 to the remote units 620, 630, and 650, and reverse link signals 690 from the remote units 620, 630, and 650 to the base stations 640.

In FIG. 6, remote unit 620 is shown as a mobile telephone, remote unit 630 is shown as a portable computer, and remote unit 650 is shown as a fixed location remote unit in a wireless local loop system. For example, the remote units may be a mobile phone, a hand-held personal communication systems (PCS) unit, a portable data unit, such as a personal data assistant, a GPS enabled device, a navigation device, a set top box, a music player, a video player, an entertainment unit, a fixed location data unit, such as meter reading equipment, or other device that stores or retrieves data or computer instructions, or combinations thereof. Although FIG. 6 illustrates remote units according to the aspects of the present disclosure, the disclosure is not limited to these exemplary illustrated units. Aspects of the present disclosure may be suitably employed in many devices, which include the disclosed coordination of low power modes in a multi-cluster architecture.

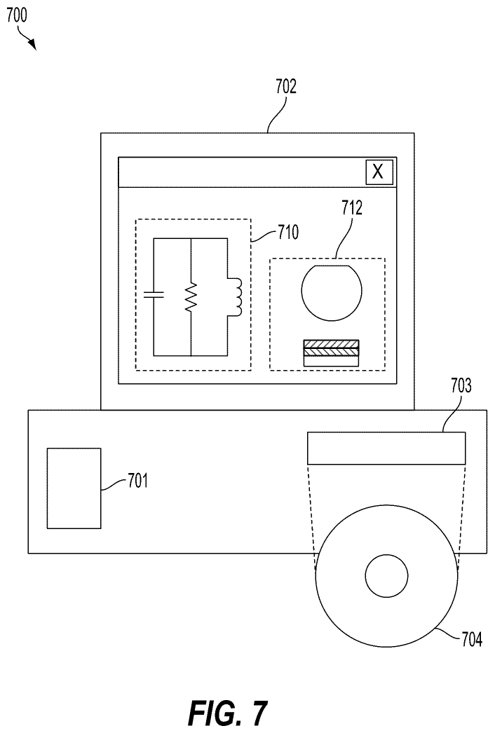

FIG. 7 is a block diagram illustrating a design workstation 700 used for circuit, layout, and logic design of a semiconductor component, such as the coordination of low power modes in a multi-cluster architecture disclosed above. The design workstation 700 includes a hard disk 701 containing operating system software, support files, and design software such as Cadence or OrCAD. The design workstation 700 also includes a display 702 to facilitate design of a circuit 710 or a semiconductor component 712, such as the coordination of low power modes in a multi-cluster architecture. A storage medium 704 is provided for tangibly storing the design of the circuit 710 or the semiconductor component 712 (e.g., the PLD). The design of the circuit 710 or the semiconductor component 712 may be stored on the storage medium 704 in a file format such as GDSII or GERBER. The storage medium 704 may be a CD-ROM, DVD, hard disk, flash memory, or other appropriate device. Furthermore, the design workstation 700 includes a drive apparatus 703 for accepting input from or writing output to the storage medium 704.

Data recorded on the storage medium 704 may specify logic circuit configurations, pattern data for photolithography masks, or mask pattern data for serial write tools such as electron beam lithography. The data may further include logic verification data such as timing diagrams or net circuits associated with logic simulations. Providing data on the storage medium 704 facilitates the design of the circuit 710 or the semiconductor component 712 by decreasing the number of processes for designing semiconductor wafers.

### EXAMPLE ASPECTS

Aspect 1: A method of low power mode sequencing, comprising: running a central processing unit (CPU) at a first clock speed; determining whether a low power mode is selected in response to cluster mode triggering; entering the low power mode in response to the low power mode being selected; waiting for an interrupt that will trigger exit of the low power mode, while in the low power mode; determining whether a lower clock speed is selected while waiting for the interrupt; reducing a clock speed of the CPU in response to the lower clock speed being selected; restoring the clock speed to the first clock speed in response to receiving the interrupt; and exiting the low power mode in parallel with restoring the clock speed.
Aspect 2: The method of Aspect 1, in which entering the low power mode comprises flushing a level two cache and resetting cache logic.
Aspect 3: The method of Aspect 1 or 2, in which entering the low power mode further comprises entering a power collapse state.
Aspect 4: The method of any of the preceding Aspects, further comprising: predicting a time for an expected wakeup for each core in the cluster while waiting for the interrupt; determining an earliest predicted time for the expected wakeup, among all cores; and reducing the clock speed in response to the earliest predicted time being greater than a threshold time.
Aspect 5: The method of any of the preceding Aspects, further comprising reducing the clock speed in response to the earliest predicted time being inaccurate when the earliest predicted time is not greater than the threshold time.
Aspect 6: The method of any of the preceding Aspects, further comprising exiting the low power mode in response to the earliest predicted time being accurate when the earliest predicted time is not greater than the threshold time.
Aspect 7: The method of any of the Aspects 1-3, further comprising exiting the low power mode, before receiving the interrupt, in accordance with the earliest predicted time.
Aspect 8: The method of any of the Aspects 1-3, further comprising exiting the low power mode a predetermined time before the earliest predicted time, the predetermined time corresponding to a worst case timeline for restoring the clock speed.
Aspect 9: An apparatus for low power mode sequencing, comprising: at least one memory; and at least one processor coupled to the at least one memory, the at least one processor configured: to run a central processing unit (CPU) at a first clock speed; to determine whether a low power mode is selected in response to cluster mode triggering; to enter the low power mode in response to the low power mode being selected; to wait for an interrupt that will trigger exit of the low power mode, while in the low power mode; to determine whether a lower clock speed is selected while waiting for the interrupt; to reduce a clock speed of the CPU in response to the lower clock speed being selected; to restore the clock speed to the first clock speed in response to receiving the interrupt; and to exit the low power mode in parallel with restoring the clock speed.
Aspect 10: The apparatus of Aspect 9, in which the at least one processor is further configured to flush a level two cache and resetting cache logic.
Aspect 11: The apparatus of any of the Aspects 9-10, in which the at least one processor is further configured to enter a power collapse state.
Aspect 12: The apparatus of any of the Aspects 9-11, in which the at least one processor is further configured: to predict a time for an expected wakeup for each core in the cluster while waiting for the interrupt; to determine an earliest predicted time for the expected wakeup, among all cores; and to reduce the clock speed in response to the earliest predicted time being greater than a threshold time.
Aspect 13: The apparatus of any of the Aspects 9-12, in which the at least one processor is further configured to reduce the clock speed in response to the earliest predicted time being inaccurate when the earliest predicted time is not greater than the threshold time.
Aspect 14: The apparatus of any of the Aspects 9-13, in which the at least one processor is further configured to exit the low power mode in response to the earliest predicted time being accurate when the earliest predicted time is not greater than the threshold time.
Aspect 15: The apparatus of any of the Aspects 9-11, in which the at least one processor is further configured to exit the low power mode, before receiving the interrupt, in accordance with the earliest predicted time.
Aspect 16: The apparatus of any of the Aspects 9-11, in which the at least one processor is further configured to exit the low power mode a predetermined time before the earliest predicted time, the predetermined time corresponding to a worst case timeline for restoring the clock speed.
Aspect 17: A non-transitory computer-readable medium having program code recorded thereon, the program code executed by a processor and comprising: program code to run a central processing unit (CPU) at a first clock speed; program code to determine whether a low power mode is selected in response to cluster mode triggering; program code to enter the low power mode in response to the low power mode being selected; program code to wait for an interrupt that will trigger exit of the low power mode, while in the low power mode; program code to determine whether a lower clock speed is selected while waiting for the interrupt; program code to reduce a clock speed of the CPU in response to the lower clock speed being selected; program code to restore the clock speed to the first clock speed in response to receiving the interrupt; and program code to exit the low power mode in parallel with restoring the clock speed.
Aspect 18: The non-transitory computer-readable medium of Aspect 17, in which the program code comprises program code to flush a level two cache and resetting cache logic.
Aspect 19: The non-transitory computer-readable medium of Aspect 17 or 18, in which the program code comprises program code to enter a power collapse state.
Aspect 20: The non-transitory computer-readable medium of any of the Aspects 17-19, in which the program code comprises: program code to predict a time for an expected wakeup for each core in the cluster while waiting for the interrupt; program code to determine an earliest predicted time for the expected wakeup, among all cores; and program code to reduce the clock speed in response to the earliest predicted time being greater than a threshold time.

For a firmware and/or software implementation, the methodologies may be implemented with modules (e.g., procedures, functions, and so on) that perform the functions described. A machine-readable medium tangibly embodying instructions may be used in implementing the methodologies described. For example, software codes may be stored in a memory and executed by a processor unit. Memory may be implemented within the processor unit or external to the processor unit. As used, the term “memory” refers to types of long term, short term, volatile, nonvolatile, or other memory and is not limited to a particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be an available medium that can be accessed by a computer. By way of example, and not limitation, such computer-readable media can include random access memory (RAM), read-only memory (ROM), electrically erasable read-only memory (EEPROM), compact disc read-only memory (CD-ROM) or other optical disk storage, magnetic disk storage or other magnetic storage devices, or other medium that can be used to store desired program code in the form of instructions or data structures and that can be accessed by a computer. Disk and disc, as used, include compact disc (CD), laser disc, optical disc, digital versatile disc (DVD), floppy disk, and Blu-ray® disc, where disks usually reproduce data magnetically, while discs reproduce data optically with lasers. Combinations of the above should also be included within the scope of computer-readable media.

In addition to storage on computer-readable medium, instructions and/or data may be provided as signals on transmission media included in a communications apparatus. For example, a communications apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions, and alterations can be made without departing from the technology of the disclosure as defined by the appended claims. For example, relational terms, such as “above” and “below” are used with respect to a substrate or electronic device. Of course, if the substrate or electronic device is inverted, above becomes below, and vice versa. Additionally, if oriented sideways, above and below may refer to sides of a substrate or electronic device. Moreover, the scope of the present disclosure is not intended to be limited to the particular configurations of the process, machine, manufacture, composition of matter, means, methods, and steps described in the specification. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding configurations described may be utilized according to the present disclosure. Accordingly, the appended claims are intended to include within their scope such processes, machines, manufacture, compositions of matter, means, methods, or steps.

Those of skill would further appreciate that the various illustrative logical blocks, modules, circuits, and algorithm steps described in connection with the present disclosure may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure may be implemented or performed with a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in RAM, flash memory, ROM, erasable programmable read-only memory (EPROM), EEPROM, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the present disclosure is provided to enable any person skilled in the art to make or use the present disclosure. Various modifications to the disclosure will be readily apparent to those skilled in the art, and the generic principles defined may be applied to other variations without departing from the spirit or scope of the disclosure. Thus, the present disclosure is not intended to be limited to the examples and designs described, but is to be accorded the widest scope consistent with the principles and novel features disclosed.

What is claimed is:

1. A method of low power mode sequencing, comprising:
running a central processing unit (CPU) at a first clock speed;
determining whether a low power mode is selected in response to cluster mode triggering;
entering the low power mode in response to the low power mode being selected;
waiting for an interrupt that will trigger exit of the low power mode, while in the low power mode;
determining whether a lower clock speed is selected while waiting for the interrupt;
reducing a clock speed of the CPU in response to the lower clock speed being selected;
restoring the clock speed to the first clock speed in response to receiving the interrupt; and
exiting the low power mode in parallel with restoring the clock speed.

2. The method of claim 1, in which entering the low power mode comprises flushing a level two cache and resetting cache logic.

3. The method of claim 2, in which entering the low power mode further comprises entering a power collapse state.

4. The method of claim 1, further comprising:
predicting a time for an expected wakeup for each core in the cluster while waiting for the interrupt;
determining an earliest predicted time for the expected wakeup, among all cores; and
reducing the clock speed in response to the earliest predicted time being greater than a threshold time.

5. The method of claim 4, further comprising reducing the clock speed in response to the earliest predicted time being inaccurate when the earliest predicted time is not greater than the threshold time.

6. The method of claim 5, further comprising exiting the low power mode in response to the earliest predicted time being accurate when the earliest predicted time is not greater than the threshold time.

7. The method of claim 4, further comprising exiting the low power mode, before receiving the interrupt, in accordance with the earliest predicted time.

8. The method of claim 7, further comprising exiting the low power mode a predetermined time before the earliest predicted time, the predetermined time corresponding to a worst case timeline for restoring the clock speed.

9. An apparatus for low power mode sequencing, comprising:
at least one memory; and
at least one processor coupled to the at least one memory, the at least one processor configured:
to run a central processing unit (CPU) at a first clock speed;
to determine whether a low power mode is selected in response to cluster mode triggering;
to enter the low power mode in response to the low power mode being selected;
to wait for an interrupt that will trigger exit of the low power mode, while in the low power mode;
to determine whether a lower clock speed is selected while waiting for the interrupt;
to reduce a clock speed of the CPU in response to the lower clock speed being selected;
to restore the clock speed to the first clock speed in response to receiving the interrupt; and
to exit the low power mode in parallel with restoring the clock speed.

10. The apparatus of claim 9, in which the at least one processor is further configured to flush a level two cache and reset cache logic.

11. The apparatus of claim 10, in which the at least one processor is further configured to enter a power collapse state.

12. The apparatus of claim 9, in which the at least one processor is further configured:
to predict a time for an expected wakeup for each core in the cluster while waiting for the interrupt;
to determine an earliest predicted time for the expected wakeup, among all cores; and
to reduce the clock speed in response to the earliest predicted time being greater than a threshold time.

13. The apparatus of claim 12, in which the at least one processor is further configured to reduce the clock speed in response to the earliest predicted time being inaccurate when the earliest predicted time is not greater than the threshold time.

14. The apparatus of claim 13, in which the at least one processor is further configured to exit the low power mode in response to the earliest predicted time being accurate when the earliest predicted time is not greater than the threshold time.

15. The apparatus of claim 12, in which the at least one processor is further configured to exit the low power mode, before receiving the interrupt, in accordance with the earliest predicted time.

16. The apparatus of claim 15, in which the at least one processor is further configured to exit the low power mode a predetermined time before the earliest predicted time, the predetermined time corresponding to a worst case timeline for restoring the clock speed.

17. A non-transitory computer-readable medium having program code recorded thereon, the program code executed by a processor and comprising:
program code to run a central processing unit (CPU) at a first clock speed;
program code to determine whether a low power mode is selected in response to cluster mode triggering;
program code to enter the low power mode in response to the low power mode being selected;
program code to wait for an interrupt that will trigger exit of the low power mode, while in the low power mode;
program code to determine whether a lower clock speed is selected while waiting for the interrupt;
program code to reduce a clock speed of the CPU in response to the lower clock speed being selected;
program code to restore the clock speed to the first clock speed in response to receiving the interrupt; and
program code to exit the low power mode in parallel with restoring the clock speed.

18. The non-transitory computer-readable medium of claim 17, in which the program code comprises program code to flush a level two cache and reset cache logic.

19. The non-transitory computer-readable medium of claim 18, in which the program code comprises program code to enter a power collapse state.

20. The non-transitory computer-readable medium of claim 17, in which the program code comprises:
program code to predict a time for an expected wakeup for each core in the cluster while waiting for the interrupt;
program code to determine an earliest predicted time for the expected wakeup, among all cores; and
program code to reduce the clock speed in response to the earliest predicted time being greater than a threshold time.
